(19) United States
(12) Patent Application Publication
(10) Pub. No.: US 2018/0322416 A1
(43) Pub. Date: Nov. 8, 2018

(54) FEATURE EXTRACTION AND CLASSIFICATION METHOD BASED ON SUPPORT VECTOR DATA DESCRIPTION AND SYSTEM THEREOF

(71) Applicant: SOOCHOW UNIVERSITY, Suzhou, Jiangshu (CN)

(72) Inventors: Li ZHANG, Suzhou (CN); Xingning LU, Suzhou (CN); Bangjun WANG, Suzhou (CN); Fanzhang LI, Suzhou (CN); Zhao ZHANG, Suzhou (CN)

(21) Appl. No.: 15/738,066

(22) PCT Filed: Dec. 19, 2016
(86) PCT No.: PCT/CN2016/110747

§ 371 Date: Jul. 19, 2018

(30) Foreign Application Priority Data
Aug. 30, 2016 (CN) 201610767804.3

(51) Int. Cl. G06N 99/00; G06F 17/50

(52) U.S. Cl. CPC G06N 99/005; G06N 3/08; G06F 17/5009

(57) ABSTRACT

A feature extraction and classification method based on support vector data description is provided, which includes: calculating, for each sample, Euclidean distances from the sample to spherical centers of multiple hypersphere models corresponding to different data categories, where the multiple hypersphere models are acquired in advance by training using a support vector data description algorithm; substituting, for each sample, the Euclidean distances and radiuses of the hypersphere models respectively corresponding to the Euclidean distances into a new feature relation equation, to acquire a new feature sample corresponding to the sample, where the new feature samples constitute a new feature sample set; and performing classification on the new feature sample set using a preset classification algorithm, to acquire a classification result. A feature extraction and classification system based on support vector data description having the above advantages is further provided.

This application claims the priority to Chinese Patent Application No. 201610767804.3, titled “FEATURE EXTRACTION AND CLASSIFICATION METHOD BASED ON SUPPORT VECTOR DATA DESCRIPTION AND SYSTEM THEREOF,” filed on Aug. 30, 2016 with the State Intellectual Property Office of People's Republic of China, which is incorporated herein by reference in its entirety.

### FIELD

The present disclosure relates to the technical field of feature extraction, and in particular to a feature extraction and classification method based on support vector data description and a system thereof.

### BACKGROUND

Feature extraction is a common dimension reduction method, and is mainly used to process a task including a large number of objects. A sample involved in this task generally includes a large amount of data with certain features, where the data may be binary data, discrete multivalued data, or continuous data. During data processing, accurate determination and decision can be obtained by using all information of all the data. However, in practical operation, raw information of the data generally includes relevance, noises, and even redundant variables or attributes. Therefore, if data is used without being processed, significant cost is involved, where the cost may relates to memory capacities, time complexity and decision accuracy. In order to improve data storage and calculation performances, a feature extraction method is required to find compact sample information from raw data.

The feature extraction is a method where critical associated information is captured from the inputted raw data to construct a new feature subset. In the feature extraction method, each new feature is a function mapping of all original features. At present, a feature extraction method based on support vector machine (SVM) is mainly used. SVM is a binary classification method based on construction of a hyperplane, where classification of various types of data is constructed in a one-to-one mode or a one-to-many mode, and a new feature is constructed by calculating a distance from a sample to the hyperplane. Although different types of data information are fully considered in this method, the computational complexity is significant in a case of a great data amount, especially in the one-to-many mode.

Therefore, the issue currently to be solved by those skilled in the art is to provide a feature extraction and classification method based on support vector data description and a system thereof having a small calculation amount.

### SUMMARY

An object of the present disclosure is to provide a feature extraction and classification method based on support vector data description and a system thereof, with which the calculation amount in feature extraction can be reduced, and the speed of data classification can be increased.

In order to address the above technical issue, a feature extraction and classification method based on support vector data description is provided according to the present disclosure, which includes:

calculating, for each sample, Euclidean distances from the sample to spherical centers of multiple hypersphere models corresponding to different data categories, where the multiple hypersphere models are acquired in advance by training using a support vector data description algorithm;

substituting, for each sample, the Euclidean distances and radiuses of the hypersphere models respectively corresponding to the Euclidean distances into a new feature relation equation, to acquire a new feature sample corresponding to the sample, where the new feature samples constitute a new feature sample set; and

performing classification on the new feature sample set using a preset classification algorithm, to acquire a classification result.

Preferably, the multiple hypersphere models may be acquired by:

dividing pre-acquired original training samples into J training subsets Xⱼ={(xᵢ,yᵢ)|xᵢ∈R^{m}, yᵢ=j,i=1, . . . , nⱼ} based on data categories, where j represents a data category, j=1, . . . , J; R^{m} represents a set of real numbers, of which a dimension is m; n represents the total number of samples in the training subsets; and nⱼ represents the number of samples in a j-th training subset,

$$n = {\sum }_{j = 1}^{J} {n}_{j} ;$$

and

training the J training subsets using the support vector data description algorithm, to acquire J hypersphere models, respectively.

Preferably, the new feature relation equation may be expressed as:

$${x}_{i}^{FE} = {[ \frac{d ( {x}_{i} , {a}_{1} )}{{R}_{1}} , \frac{d ( {x}_{i} , {a}_{2} )}{{R}_{2}} , … , \frac{d ( {x}_{i} , {a}_{J} )}{{R}_{J}} ]}^{T} ,$$

where the new feature sample is xᵢF^{E}, xᵢ^{FE}∈R^{J}, i×1, . . . , n; Rⱼ represents a radius of the hypersphere model corresponding to the j-th training subset; and aⱼ represents a spherical center of the hypersphere model corresponding to the j-th training subset.

Preferably, the preset classification algorithm may include a neural network classification algorithm or a support vector machine classification algorithm.

In order to address the above technical issue, a feature extraction and classification system based on support vector data description is further provided according to the present disclosure, which includes:

a distance calculation unit configured to calculate, for each sample, Euclidean distances from the sample to spherical centers of multiple hypersphere models corresponding to different data categories, where the multiple hypersphere models are acquired in advance by training using a support vector data description algorithm;

a new feature generation unit configured to substitute, for each sample, the Euclidean distances and radiuses of the hypersphere models respectively corresponding to the Euclidean distances into a new feature relation equation, to acquire a new feature sample corresponding to the sample, where the new feature samples constitute a new feature sample set; and

a classification unit configured to perform classification on the new feature sample set using a preset classification algorithm, to acquire a classification result.

Preferably, the classification unit may be a neural network classifier or a support vector machine classifier.

With the feature extraction and classification method based on support vector data description according to the present disclosure, the Euclidean distances from the sample to the spherical centers of the multiple preset hypersphere models are calculated, a new feature sample corresponding to the sample is calculated based on the Euclidean distances and the spherical centers of hypersphere models respectively corresponding to the Euclidean distances, thereby acquiring the new feature sample set, and classification is performed on the new feature sample set. According to the present disclosure, feature extraction is performed by using the hypersphere model in the support vector data description algorithm, and the extracted new feature samples are classified. As compared with the SVM algorithm, the calculation amount is reduced, and the speed of data classification is increased. The feature extraction and classification system based on support vector data description is further provided according to the present disclosure, which also has the above effects and is not described in detail here.

### BRIEF DESCRIPTION OF THE DRAWINGS

The drawings to be used in the description of the embodiments of the application or the conventional technology will be described briefly as follows, so that the technical solutions according to the embodiments of the present application or according to the conventional technology will become clearer. It is apparent that the drawings in the following description only illustrate some embodiments of the present application. For those skilled in the art, other drawings may be obtained according to these drawings without any creative work.

FIG. 1 is a flowchart illustrating a procedure of a feature extraction and classification method based on support vector data description according to the present disclosure; and

FIG. 2 is a schematic structural diagram of a feature extraction and classification system based on support vector data description according to the present disclosure.

### DETAILED DESCRIPTION OF THE EMBODIMENTS

The core of the present disclosure is to provide a feature extraction and classification method based on support vector data description and a system thereof, with which a calculation amount in feature extraction can be reduced, and the speed of data classification can be increased.

In order to make the object, technical solutions and advantages of the present disclosure clearer, technical solutions according to embodiments of the present disclosure are described clearly and completely hereinafter in conjunction with drawings used in the embodiments of the present disclosure. Apparently, the described embodiments are only some rather than all of the embodiments of the present disclosure. Any other embodiments obtained by those skilled in the art based on the embodiments of the present disclosure without any creative work fall in the scope of protection of the present disclosure.

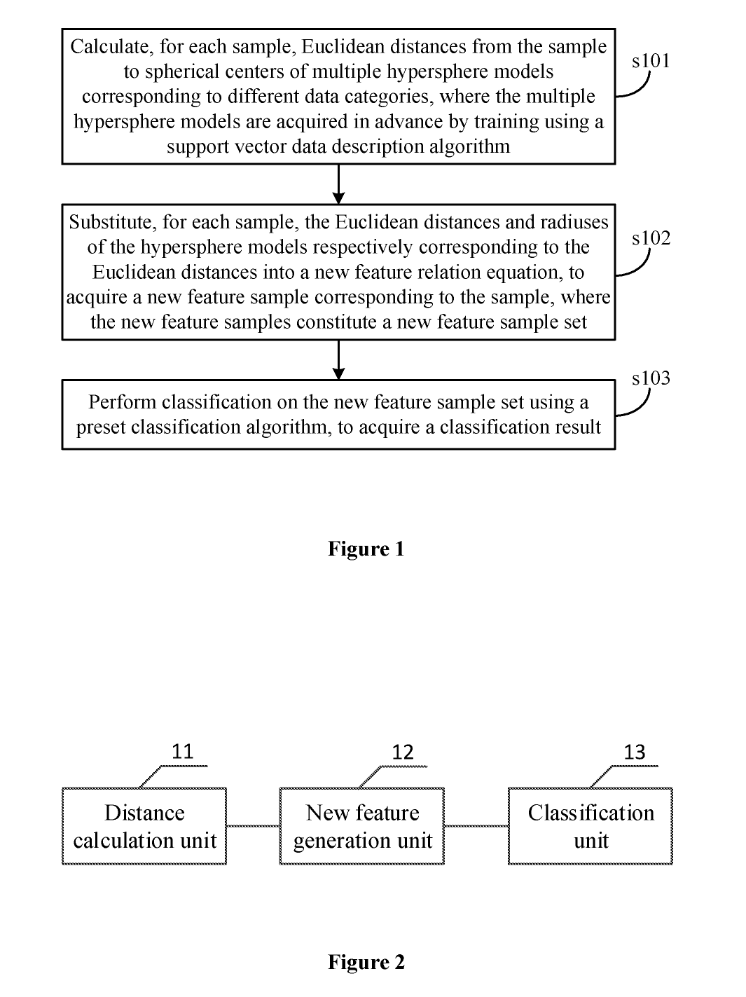

A feature extraction and classification method based on support vector data description is provided according to the present disclosure. As shown in FIG. 1, which is a flowchart illustrating a procedure of a feature extraction and classification method based on support vector data description according to the present disclosure, the method includes the following step s101 to step s103.

In step s101, for each sample, Euclidean distances from the sample to spherical centers of multiple hypersphere models corresponding to different data categories are calculated. The multiple hypersphere models are acquired in advance by training using a support vector data description algorithm.

In step s102, for each sample, the Euclidean distances and radiuses of hypersphere models respectively corresponding to the Euclidean distances are substituted into a new feature relation equation, to acquire a new feature sample corresponding to the sample. The new feature samples constitute a new feature sample set.

In step s103, classification is performed on the new feature sample set using a preset classification algorithm, to acquire a classification result.

The preset classification algorithm includes:

a neural network classification algorithm or a support vector machine classification algorithm. Of course, other classification algorithms may also be used, which is not limited in the present disclosure.

Preferably, the multiple hypersphere models are acquired by the following steps.

Pre-acquired original training samples are divided into J training subsets Xⱼ={(xᵢ,yᵢ)|xᵢ∈R^{m},yᵢ=j,i=1, . . . , nⱼ} based on data categories, where j represents a data category, j=1, . . . , J; R^{m} represents a set of real numbers, of which a dimension is m; n represents the total number of samples in the training subsets; and nⱼ represents the number of samples in a j-th training subset,

$$n = {\sum }_{j = 1}^{J} {n}_{j} .$$

The J training subsets are trained using the support vector data description algorithm, to acquire J hypersphere models, respectively.

The new feature relation equation is expressed as:

$${x}_{i}^{FE} = {[ \frac{d ( {x}_{i} , {a}_{1} )}{{R}_{1}} , \frac{d ( {x}_{i} , {a}_{2} )}{{R}_{2}} , … , \frac{d ( {x}_{i} , {a}_{J} )}{{R}_{J}} ]}^{T} .$$

In the above equation, the new feature sample is xᵢ^{FE}, xᵢ^{FE}∈R^{J},i=1, . . . , n; Rⱼ represents a radius of the hypersphere model corresponding to the j-th training subset; and aⱼ represents a spherical center of the hypersphere model corresponding to the j-th training sub set.

The number of the hypersphere models used for calculating the new feature sample set is determined based on the actual number of the data categories. The number of categories and content of the training subsets are not limited in the present disclosure.

It should be understood that a data dimension of the original training samples is m. That is, a dimension of the origional training samples is m in a case where the new feature sample of the sample is calculated using the hypersphere models. As can be seen from the above new relation equation, a dimension of the new feature samples is J, and the number J of the categories is generally less than m. Therefore, the data dimension can be reduced with the feature extraction method based on support vector data description according to the present disclosure.

For further understanding of the beneficial effects of the present disclosure, reference is made to the following Table 1 to Table 3. Table 1 shows description of an Isolet dataset in a specific embodiment, Table 2 shows a result of comparison between classification effects of the present disclosure and the SVM algorithm, and Table 3 shows a result of comparison between operation durations of the present disclosure and the SVM algorithm.

TABLE 1
Description of an Isolet dataset in a specific embodiment

| | | | Total | Number of | |
|---|---|---|---|---|---|
| | | Number of | number of | training | Number of |
| Dataset | Categories | features | samples | samples | tested samples |
| Isolet | 26 | 617 | 7797 | 6238 | 1559 |

TABLE 2
Result of Comparison between classification effects of the present
disclosure and the SVM algorithm (%)

| | Classifier | |
|---|---|---|
| | | Support |
| Algorithm | Neural network | vector machine |
| The present disclosure | 93.59 | 90.64 |
| Feature extraction based on SVM | 92.23 | 86.72 |
| (one-to-one) | | |
| Feature extraction based on SVM | 92.25 | 90.07 |
| (one-to-multiple) | | |

TABLE 3
Result of comparison between operation durations of the present
disclosure and the SVM algorithm

| | | Feature extraction | Feature extraction |
|---|---|---|---|
| | The present | based on | based on |
| | disclosure | SVM (one-to-one) | SVM (one-to-many) |
| Duration | 204 | 3412 | 1239 |
| (seconds) | | | |

With the feature extraction and classification method based on support vector data description according to the present disclosure, the Euclidean distances from the sample to the spherical centers of the multiple preset hypersphere models are calculated, a new feature sample corresponding to the sample is calculated based on the Euclidean distances and the spherical centers of hypersphere models respectively corresponding to the Euclidean distances, thereby acquiring the new feature sample set, and classification is performed on the new feature sample set. According to the present disclosure, feature extraction is performed by using the hypersphere model in the support vector data description algorithm, and the extracted new feature samples are classified. As compared with the SVM algorithm, the calculation amount is reduced, the classification effect is improved, the operation duration is reduced, and the speed of data classification is increased.

A feature extraction and classification system based on support vector data description is further provided according to the present disclosure. As shown in FIG. 2, which is a schematic structural diagram of a feature extraction and classification system based on support vector data description according to the present disclosure, the system includes a distance calculation unit 11, a new feature generation unit 12, and a classification unit 13.

The distance calculation unit 11 is configured to calculate, for each sample, Euclidean distances from the sample to spherical centers of multiple hypersphere models corresponding to different data categories. The multiple hypersphere models are acquired in advance by training using a support vector data description algorithm.

The new feature generation unit 12 is configured to substitute, for each sample, the Euclidean distances and radiuses of the hypersphere models respectively corresponding to the Euclidean distances into a new feature relation equation, to acquire a new feature sample corresponding to the sample. The new feature samples constitute a new feature sample set.

The classification unit 13 is configured to perform classification on the new feature sample set using a preset classification algorithm, to acquire a classification result.

Specifically, the classification unit 13 is:

a neural network classifier or a support vector machine classifier. Of course, the present disclosure is not limited thereto.

With the feature extraction and classification system based on support vector data description according to the present disclosure, the Euclidean distances from the sample to the spherical centers of the multiple preset hypersphere models are calculated, a new feature sample corresponding to the sample is calculated based on the Euclidean distances and the spherical centers of hypersphere models respectively corresponding to the Euclidean distances, thereby acquiring the new feature sample set, and classification is performed on the new feature sample set. According to the present disclosure, feature extraction is performed by using the hypersphere model in the support vector data description algorithm, and the extracted new feature samples are classified. As compared with the SVM algorithm, the calculation amount is reduced, the classification effect is improved, the operation duration is reduced, and the speed of data classification is increased.

It should be noted that, the terms “include”, “comprise” or any variants thereof in the embodiments of the disclosure are intended to encompass nonexclusive inclusion so that a process, method, article or apparatus including a series of elements includes both those elements and other elements which are not listed explicitly or an element(s) inherent to the process, method, article or apparatus. Without much more limitation, an element being defined by a sentence “include/comprise a(n) . . . ” will not exclude presence of an additional identical element(s) in the process, method, article or apparatus including the element.

The above illustration of the disclosed embodiments enables those skilled in the art to implement or practice the present disclosure. Many changes to these embodiments are apparent for those skilled in the art, and general principles defined herein can be implemented in other embodiments without departing from the spirit or scope of the present disclosure. Hence, the present disclosure is not limited to the embodiments disclosed herein, but is to conform to the widest scope consistent with principles and novel features disclosed herein.

1. A feature extraction and classification method based on support vector data description, comprising:
calculating, for each sample, Euclidean distances from the sample to spherical centers of a plurality of hypersphere models corresponding to different data categories, wherein the plurality of hypersphere models are acquired in advance by training using a support vector data description algorithm;
substituting, for each sample, the Euclidean distances and radiuses of the hypersphere models respectively corresponding to the Euclidean distances into a new feature relation equation, to acquire a new feature sample corresponding to the sample, wherein the new feature samples constitute a new feature sample set; and
performing classification on the new feature sample set using a preset classification algorithm, to acquire a classification result.

2. The method according to claim 1, wherein the plurality of hypersphere models are acquired by:
dividing pre-acquired original training samples into J training subsets Xⱼ={(xᵢ,yᵢ)|xᵢ∈R^{m},yᵢ=j,i=1, . . . , nⱼ} based on data categories, wherein j represents a data category, j=1, . . . , J; R^{m} represents a set of real numbers, of which a dimension is m; n represents the total number of samples in the training subsets; and nⱼ represents the number of samples in a j-th training subset,
$$n = {\sum }_{j = 1}^{J} {n}_{j} ;$$
and
training the J training subsets using the support vector data description algorithm, to acquire J hypersphere models, respectively.

3. The method according to claim 2, wherein the new feature relation equation is expressed as:
$${x}_{i}^{FE} = {[ \frac{d ( {x}_{i} , {a}_{1} )}{{R}_{1}} , \frac{d ( {x}_{i} , {a}_{2} )}{{R}_{2}} , … , \frac{d ( {x}_{i} , {a}_{J} )}{{R}_{J}} ]}^{T} ,$$
wherein the new feature sample is xᵢ^{FE}, xᵢ^{FE}∈R^{J}, i=1, . . . , n; Rⱼ represents a radius of the hypersphere model corresponding to the j-th training subset; and aⱼ represents a spherical center of the hypersphere model corresponding to the j-th training subset.

4. The method according to claim 3, wherein the preset classification algorithm comprises a neural network classification algorithm or a support vector machine classification algorithm.

5. A feature extraction and classification system based on support vector data description, comprising:
a distance calculation unit configured to calculate, for each sample, Euclidean distances from the sample to spherical centers of a plurality of hypersphere models corresponding to different data categories, wherein the plurality of hypersphere models are acquired in advance by training using a support vector data description algorithm;
a new feature generation unit configured to substitute, for each sample, the Euclidean distances and radiuses of the hypersphere models respectively corresponding to the Euclidean distances into a new feature relation equation, to acquire a new feature sample corresponding to the sample, wherein the new feature samples constitute a new feature sample set; and
a classification unit configured to perform classification on the new feature sample set using a preset classification algorithm, to acquire a classification result.

6. The system according to claim 5, wherein the classification unit is a neural network classifier or a support vector machine classifier.
